(19) United States
(12) Patent Application Publication
(10) Pub. No.: US 2007/0115820 A1
(43) Pub. Date: May 24, 2007

(54) Apparatus and method for creating and managing TCP transmission information based on TOE

(75) Inventors: Sun-Wook Kim, Daejon (KR); Chan-Ho Park, Daejon (KR); Seong-Woon Kim, Daejon (KR); Myung-Joon Kim, Daejon (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Electronics and Telecommunications Research Institute

(21) Appl. No.: 11/499,508

(22) Filed: Aug. 4, 2006

(30) Foreign Application Priority Data
Nov. 3, 2005 (KR) 10-2005-0105055

(51) Int. Cl. H04L 12/26; H04J 3/14; H04L 1/00

(52) U.S. Cl. 370/231

(57) ABSTRACT

Provided is an apparatus and a method for creating and managing Transmission Control Protocol (TCP) transmission information based on a TCP Offload Engine (TOE). The apparatus includes: a TCP transmission processing unit for receiving a data transmission request from a predetermined network program, creating transmission information and deleting the transmission information; a TCP reception processing unit for receiving a reception command of the data, creating and managing the reception information; a transmission information region managing unit for allocating memory regions for storing the transmission information according to a command of the TCP transmission processing unit, creating an identification (ID) of each region, and managing a deleting process; and a storing unit for storing and deleting the transmission information according to control of the TCP transmission processing unit.

### FIELD OF THE INVENTION

The present invention relates to an apparatus and method for creating and managing Transmission Control Protocol (TCP) transmission information based on a TCP Offload Engine (TOE) when data of an application program are transmitted through a TCP layer in a network application program using a network protocol layer; and, more particularly, to an apparatus and method for creating and managing information related to data transmission of an network application program through an exclusive hardware logic in the TOE using hardware to accelerate the TCP.

### DESCRIPTION OF RELATED ART

Generally, a server-client relationship is formed among systems connected through a network. A program such as a network program is used for communication between the server and the client. The network program transmits and receives data on the network through a socket which is a communication connection point formed as software.

In transmission of the data through the socket, the data stored in a memory are transferred to a transmission buffer of a network interface through a bus, and transmitted to a network through a controller. In reception of the data, the data are transmitted to the memory through a reception buffer. The above procedures are performed by an operating system through an application program.

In a data transmitting procedure by the operating system, an application program buffer for storing the transmission data is created by message creation routine of the application program. When a data transmission command is transmitted to the operating system, the data are copied into a socket buffer of an operating system kernel. The operating system forms a packet with the data of the kernel buffer, copies a header and data of the formed packet into the network interface and transmits the header and the data.

While the transmitted data are transmitted from the network interface to the buffer of the application program in the data reception, the data are copied twice. That is, since all transmission/reception data are copied into the socket buffer, memory usage and the amount of the data increase. Accordingly, there is a problem that the packet processing rate of a network device becomes slow.

As described above, the data of the application program is directly transmitted to the transmission buffer in the inside of the network interface instead of the socket buffer in the inside of the operating system in order to solve the overhead problem caused by copying the data. It is called direct memory access (DMA), which requires a module supporting memory mapping of the application program in the operating system. Also, information of the transmission data should be managed in the application program or the operating system. Since the data are transmitted without using the socket buffer in the inside of the operating system, a typical network protocol supported in the operating system and a typical network application program should be modified. That is, there is a problem that all typical network application programs should be reprogrammed. When the transmission information of the data is managed in the operating system, the quantity of the data which should be managed in the operating system increases according to the increase in the number of sockets and the data transmission through the DMA. Accordingly, overhead may be increased a lot because a processor processes the protocol and manages the information.

Whenever the transmitted data are retransmitted due to an error on the network, an address of the data managed in the operating system is required to copy the data into the network interface buffer. Accordingly, there is a problem that intervention of the processor is required.

The problems mentioned above can be summarized as follows. In the first place, overhead is caused by two-time data copy performed while the data of an application program is transmitted to the transmission buffer in the inside of the network interface in case that socket buffer in the typical operating system is used in transmission of the data. Secondly, overhead is caused by reprogramming of typical network application programs due to in-compatibility when the DMA technique is used to solve the overhead problem caused by the two time data copy, and by correcting of an operating system protocol stack. Thirdly, the intervention of the processor is required since the address of the data is required whenever data are retransmitted.

### SUMMARY OF THE INVENTION

It is, therefore, an object of the present invention to provide an apparatus and method for creating and managing Transmission Control Protocol (TCP) transmission information based on a TCP Offload Engine (TOE).

Specifically, the object of the invention is to reduce the number of memory access caused by the data copy for data transmission in network protocol stack of typical operating system and the system overhead caused by the increase of data transmission information and data retransmission. It is possible that the exclusive hardware device in TOE creates and manages data transmission information instead of software such as network protocol stack in the Operating System (OS).

Other objects and advantages of the invention will be understood by the following description and become more apparent from the embodiments in accordance with the present invention, which are set forth hereinafter. It will be also apparent that objects and advantages of the invention can be embodied easily by the means and its combinations specified in claims.

In accordance with the present invention, there is provided an apparatus for creating and managing TCP transmission information based on TOE, the apparatus including: a TCP transmission processing unit for receiving a data transmission request from a predetermined network program, creating transmission information based on address and size information of data to be transmitted, and deleting the transmission information when the transmission completion is confirmed; a TCP reception processing unit for receiving a reception command of the data, creating and managing the reception information based on address and size information of a region to be used for data reception; a transmission information region managing unit for allocating memory regions for storing the transmission information according to a command of the TCP transmission processing unit, creating and deleting an identification (ID) of each region; and a storing unit for storing and deleting the transmission information according to control of the TCP transmission processing unit.

In accordance with another aspect of the present invention, there is provided a method for creating and managing TCP transmission information based on TOE, including the steps of: a) receiving a creation command of a transmission information storing region from the TCP transmission processing unit, creating a new allocation region ID with reference to a pre-allocated region ID, and creating an allocation completion mark in the transmission information region managing unit; b) checking a creation completion mark of the allocation region ID of the step a) and calculating a region to be stored in a predetermined memory through the created region ID in the TCP transmission processing unit; and c) storing the transmission information in the calculated storing region of the predetermined memory and managing the transmission information connected with the socket in the TCP transmission processing unit.

### BRIEF DESCRIPTION OF THE DRAWINGS

The above and other objects and features of the present invention will become apparent from the following description of the preferred embodiments given in conjunction with the accompanying drawings, in which:

FIG. 1 is a block diagram showing an apparatus for creating and managing Transmission Control Protocol (TCP) transmission information based on a TCP Offload Engine (TOE) in accordance with an embodiment of the present invention;

FIG. 2 is a diagram showing a structure of transmission information which is created and managed by the apparatus based on TOE in accordance with the embodiment of the present invention;

FIG. 3 is a block diagram showing the transmission information region managing unit of FIG. 1;

FIG. 4 is a diagram describing formats of an allocation command register and an allocation result register shown in FIG. 3; and

FIG. 5 is a flowchart showing a process for creating and managing the TCP transmission information based on the TOE in accordance with an embodiment of the present invention.

### DETAILED DESCRIPTION OF THE INVENTION

Other objects and advantages of the present invention will become apparent from the following description of the embodiments with reference to the accompanying drawings. Therefore, those skilled in the art that the present invention is included can embody the technological concept and scope of the invention easily. In addition, if it is considered that detailed description on a related art may obscure the points of the present invention, the detailed description will not be provided herein. The preferred embodiments of the present invention will be described in detail hereinafter with reference to the attached drawings.

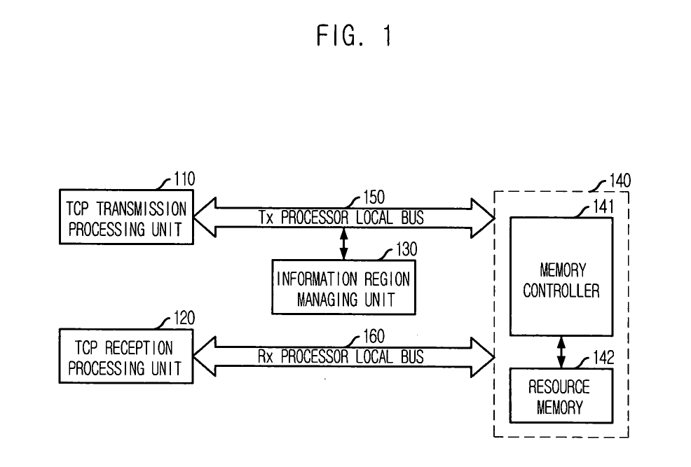

FIG. 1 is a block diagram showing an apparatus for creating and managing Transmission Control Protocol (TCP) transmission information based on a TCP Offload Engine (TOE) in accordance with an embodiment of the present invention.

The apparatus of the present invention processes a TCP protocol individually in transmission and reception processors. The transmission processor creates and deletes data transmission information, and the reception processor creates and deletes data reception information. The apparatus is used when socket information and data transmission information are stored in an internal memory of a hardware device. It will be described in detail hereinafter.

As shown in FIG. 1, the apparatus for creating and managing the TCP transmission information based on the TOE, which is suggested in the present invention includes a TCP transmission processing unit 110, a TCP reception processing unit 120, a transmission information region managing unit 130 and a memory unit 140.

The TCP transmission processing unit 110 receives a data transmission request of a predetermined network program, creates transmission information based on address and size information of the data to be transmitted, and deletes the transmission information when it is checked that the transmission is completed.

The TCP reception processing unit 120 receives a reception command of the data, and creates and manages reception information based on address and size information of a region to be used in data reception.

The transmission information region managing unit 130 allocates a memory region for storing transmission information upon receipt of a command from the TCP transmission processing unit and manages creation and deletion process of identification (ID) of the region.

The memory unit 140 stores and deletes the transmission information according to control of the TCP transmission processing unit 110.

The transmission information region managing unit 130 is connected to the TCP transmission processing unit 110 through a Tx processor local bus 150, which is a transmission processor local bus.

The memory unit 140 is connected to the TCP transmission processing unit 110 and the transmission information region managing unit 130 through the Tx processor local bus 150, and connected with the TCP reception processing unit 120 through an Rx processor local bus 160, which is a reception processor local bus. The memory unit 140 includes a resource memory 142 and a memory controller 141. The resource memory 142 stores socket information and data transmission information. The memory controller 141 controls the resource memory 142 under the control of the TCP transmission processing unit 110 or the TCP reception processing unit 120.

Meanwhile, the transmission information means an attribute of a data region to be transmitted by the application program or a transmitted data region. For example, the transmission information includes a physical address of the transmission data, a send flag, a size, ID and an address of next transmission information region. Herein, the send flag shows the presence of transmission and the ID is created by the transmission information region managing unit 130.

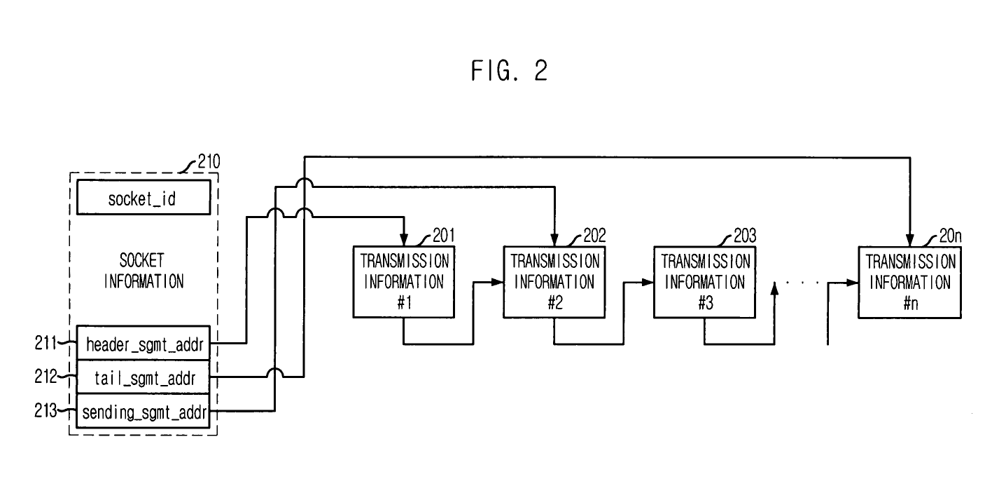

FIG. 2 is a diagram showing a structure of TCP transmission information created and managed by the apparatus based on TOE in accordance with the embodiment of the present invention. The Transmission information is used for TCP data transmission. Reference numerals 201 to 20n is transmission information; a reference numeral 210 is a socket; a reference numeral 211 is a “header_sgmt_addr” field; a reference numeral 212 is a “tall_sgmt_addr” field; and a reference numeral 213 is a “sending_sgmt_addr” field.

The creation and management of the transmission information can be divided into three operations.

One is an operation for creating transmission information in the TCP transmission processing unit 110 upon a request of the network program and requesting region allocation to store created information. Another is an operation for searching the transmission information on the transmitted data based on information of acknowledgement packet transmitted to the TCP reception processing unit 120, and requesting deletion of the transmission information and release of the region. The other is the management of transmission information when the data based on transmission information are transmitted or new transmission command is received and the completion of data transmission based on transmission information is checked by the TCP transmission processing unit 110.

The storing region allocation and release of the transmission information are performed by giving a command to a allocation command register of the transmission information region managing unit 30.

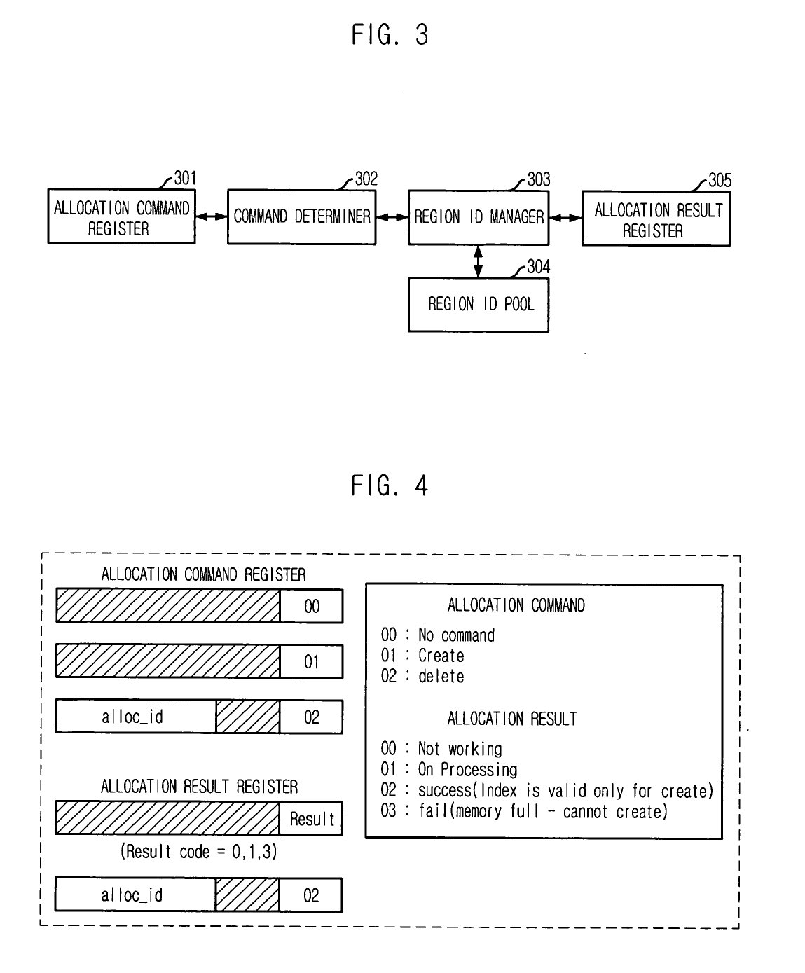

A process for creating and managing the transmission command will be described in detail with reference to FIG. 3.

FIG. 3 is a block diagram showing the transmission information region managing unit of FIG. 1. The transmission region managing unit 130 includes an allocation command register 301, a command determiner 302, a region ID manager 303, a region ID pool 304 and an allocation result register 305.

The allocation command register 301 receives a predetermined command from the TCP transmission processing unit 110.

The command determiner 302 checks the command which the allocation command register 301 receives, and determines contents of the command.

The region ID manager 303 manages an allocation region ID upon receipt of the determined command of the command determiner 302.

The region ID pool 304 stores an allocated region ID.

The allocation result register 305 stores a process result of the region ID manager 303 and is connected with the TCP transmission processing unit 110.

FIG. 4 is a diagram describing formats of an allocation command register and an allocation result register shown in FIG. 3. It shows creation, deletion and management of transmission information.

The creating process of the transmission information is performed as follows.

When the transmission information region managing unit 130 receives an allocation command from the TCP transmission processing unit 110, the transmission information region managing unit 130 creates a new allocation region ID with reference to the pre-allocated region ID, and creates an allocation completion mark. It will be described in detail as follows.

A predetermined network program requests the TCP transmission processing unit 110 to transmit data.

When the TCP transmission processing unit 110 receives data transmission request, the TCP transmission processing unit 110 sends a creation command, which is substantially Create of “01”, to a command field of the allocation command register 301 shown in FIG. 3 for reserving a region to store the transmission information.

The command determiner 302 analyzes the command and requests the region ID manager 303 to create a new region ID in case of creation of a region.

The region ID manager 303 receiving a creation request of the region ID creates the region ID with reference to a state of the region ID pool 304. Herein, the region ID can be created sequentially or based on a method allowing a certain blank ID to the region.

The created region ID is stored in an alloc_id field of the allocation result register 305, and Success of “02” is marked in a Result field. The TCP transmission processing unit 110 checks the allocation result register 305, calculates an address to be stored in the resource memory 142 of the memory unit 140 based on the region ID and stores created transmission information in the region.

A deleting process of the transmission information is as follows.

When the transmission information region managing unit 130 receives an allocation release command from the TCP transmission processing unit 110, the transmission information region managing unit 130 deletes the region ID among the stored allocation region ID and creates an allocation release completion mark.

When it is described in detail, the TCP transmission processing unit 110 searches for transmission information of data which are transmitted using information of the acknowledge packet which the TCP reception processing unit 120 receives, and gives a deletion command of “02” to a command field of the allocation command register 301 in FIG. 3 for releasing a region allocated for the transmission information. The ID of the region is recorded in the alloc_id field.

The command determiner 302 interprets the command and requests the region ID manager 303 to delete the region ID when the command is for releasing of the region.

The region ID manager 303 receiving the request to delete the region ID resets a field value of the region ID and marks “02” meaning success in a Result field of the allocation result register 305.

A transmission information managing process by the TCP transmission processing unit 110 is as follows.

Referring to a structure of the transmission information shown in FIG. 2, when the TCP transmission processing unit 110 receives the transmission command, the TCP transmission processing unit 110 acquires a region for storing the transmission information formed through the transmission information region managing unit 130 and stores the information.

If a previously formed transmission information 203 exists in a socket 210 used by the received transmission command, an address of newly created transmission information is stored in a “tail_sgmt_addr” field 212 of the socket 210 and a “next_sgmt_addr” field of previous transmission information.

When the created transmission information is a first transmission information 202 of the socket 210, the address of the created transmission information is stored in a “header_sgmt_addr” field 211 and the “tail_sgmt_addr” field 212 of the socket.

When data of the stored transmission information are transmitted, an address of the transmission information 202 in processing of transmission is stored in a “sending_sgmt_addr” field 213 of the socket. This operation makes it easy to search for transmission information to be transmitted next.

When the transmission information whose transmission completion is confirmed through an acknowledge packet that the TCP reception processing unit 120 receives is processed, the reception of the acknowledge packet is performed in the order that transmission information is transmitted due to characteristics of the TCP protocol. Accordingly, the receptions of the transmission acknowledge packets are sequentially checked from the transmission information indicated by the “header_sgmt_addr” field 211 of the socket.

The region of the transmission information whose transmission is confirmed is released and the next transmission information whose transmission is not confirmed is stored in the “header_sgmt_addr” field 211 of the socket. When the transmission information with transmission confirmation is the same as the transmission information indicated by the “tail_sgmt_addr” field 212, it means that the transmission information does not exist in the socket. Thus, the “header_sgmt_addr” field 211, the “tail_sgmt_addr” field 212 and the “sending_sgmt_addr” field 213 of the socket are initialized.

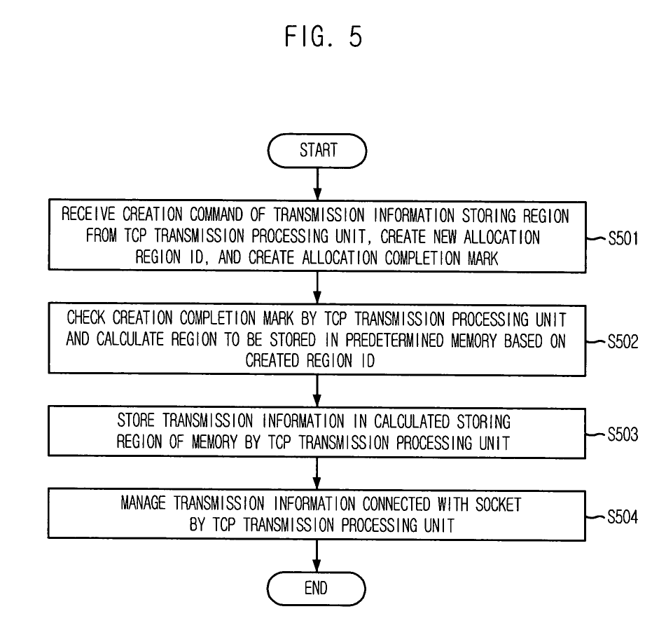

FIG. 5 is a flowchart showing a process for creating and managing the TCP transmission information based on the TOE in accordance with an embodiment of the present invention.

As shown in FIG. 5, a method for creating and managing the TCP transmission information of the present invention is as follows.

When the TCP transmission processing unit makes a command to create a region for storing transmission information, a new allocation region ID is created with reference to the pre-allocated region ID and allocation completion mark is created at step S501. The TCP transmission processing unit checks the creation completion mark of the allocation region ID and calculates a region to be stored in a predetermined memory based on the created region ID at step S502.

The TCP transmission processing unit stores the transmission information in the calculated storing region of the memory at step S503, and the TCP transmission processing unit manages the transmission information connected with the socket at step S504.

The present invention can efficiently create and manage the TCP transmission information based on the TOE to accelerate the TCP protocol processing and prevent the increase of system load caused by an increase in the creation and management of data transmission information by a server process and a client process in a system. As a consequence, the degradation of system performance caused due to an increase in the creation and management of data transmission information can be prevented.

As described in detail, the technology of the present invention can be realized as a program and stored in a computer-readable recording medium, such as CD-ROM, RAM, ROM, a floppy disk, a hard disk and a magneto-optical disk. Since the process can be easily implemented by those skilled in the art of the present invention, further description will not be provided herein.

The present application contains subject matter related to Korean patent application No. 2005-0105055, filed with the Korean Intellectual Property Office on Nov. 3, 2005, the entire contents of which are incorporated herein by reference.

While the present invention has been described with respect to certain preferred embodiments, it will be apparent to those skilled in the art that various changes and modifications may be made without departing from the scope of the invention as defined in the following claims.

What is claimed is:

1. An apparatus for creating and managing Transmission Control Protocol (TCP) transmission information based on a TCP Offload Engine (TOE), comprising:
a TCP transmission processing means for receiving a data transmission request from a predetermined network program, creating transmission information based on address and size information of data to be transmitted, and deleting the transmission information when the transmission completion is confirmed;
a TCP reception processing means for receiving a reception command of the data, creating and managing the reception information based on address and size information of a region to be used for data reception;
a transmission information region managing means for allocating memory regions for storing the transmission information according to a command of the TCP transmission processing means, creating and deleting an identification (ID) of each region; and
a storing means for storing and deleting the transmission information according to control of the TCP transmission processing means.

2. The apparatus as recited in claim 1, wherein the transmission information region managing means is connected with the TCP transmission processing means through a transmission processor local bus.

3. The apparatus as recited in claim 1, wherein the storing means includes:
a resource storing unit for storing socket information and data transmission information; and
a memory controlling unit for controlling the resource storing unit according to control of the TCP transmission processing means and TCP reception processing means.

4. The apparatus as recited in claim 3, wherein the storing means is connected with the TCP transmission processing means and the transmission information region managing means through the transmission processor local bus, and connected with the TCP reception processing means through the reception processor local bus.

5. The apparatus as recited in claim 1, wherein the transmission information region managing means includes:
an allocation command registering unit for receiving a predetermined command from the TCP transmission processing means;
a command determining means for checking the command that the allocation command registering unit receives and determining contents of the command;
a region ID managing unit for managing an allocation region ID according to the command determined by the command determining means;
a region ID storing unit for storing the allocation region ID; and
an allocation result registering unit which stores a process result of the region ID managing unit and is connected with the TCP transmission processing means.

6. The apparatus as recited in claim 5, wherein the transmission information means an attribute of a data region to be transmitted or transmitted by the application program, and includes Physical Address, which is a physical address of the transmission data, a send flag, which indicates whether the data are transmitted or not, a size, an ID created by the transmission information region managing means and an address of a next transmission information region.

7. A method for creating and managing TCP transmission information based on TOE, comprising the steps of:
a) receiving a creation command of a transmission information storing region from the TCP transmission processing unit, creating a new allocation region identification (ID) with reference to a pre-allocated region ID, and creating an allocation completion mark in the transmission information region managing unit;
b) checking a creation completion mark of the allocation region ID of the step a) and calculating a region to be stored in a predetermined memory through the created region ID in the TCP transmission processing unit; and
c) storing the transmission information in the calculated storing region of the predetermined memory and managing the transmission information connected with the socket in the TCP transmission processing unit.

8. The method as recited in claim 7, wherein the step a) includes the steps of:
a1) writing the creation command in the command field of an allocation command register to allocate a region to store the transmission information in the transmission information region managing unit when the TCP transmission processing unit receives a data transmission request from a predetermined network program;
a2) analyzing the command transmitted in the step a1) and requesting a region ID manager to create a new region ID in the command determiner;
a3) creating a region ID with reference to a condition of a region ID pool in the region ID manager upon the request to create the region ID in the step a2); and
a4) storing the region ID created in the step a3) in an ID allocation field of an allocation result register and marking command completion in a Result field.

9. The method as recited in claim 8, wherein in the step b), the TCP transmission processing unit checks the allocation result register, calculates an address to be stored in a resource memory of the memory unit based on the region ID and stores the created transmission information in the region.

10. The method as recited in claim 8, wherein when the transmission information region managing unit receives an allocation release command from the TCP transmission processing unit, the transmission information region managing unit deletes the region ID among the stored allocation region ID and creates an allocation release completion mark.

11. The method as recited in claim 7, wherein in the step c), when the TCP transmission processing unit receives a transmission command, the TCP transmission processing unit acquires a region to store the transmission information formed in the transmission information region managing unit and stores the information.
